(19) United States
(12) Patent Application Publication
(10) Pub. No.: US 2006/0144721 A1
(43) Pub. Date: Jul. 6, 2006

(54) Calibration method and apparatus for potentiostats

(75) Inventors: Verena S. Bonitz, Fargo, ND (US); Brian R. Hinderliter, Fargo, ND (US); Gordon P. Bierwagen, Fargo, ND (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: NDSU Research Foundation, Fargo, ND (US)

(21) Appl. No.: 11/283,524

(22) Filed: Nov. 18, 2005

Related U.S. Application Data
(60) Provisional application No. 60/692,988, filed on Jun. 22, 2005.
(60) Provisional application No. 60/629,188, filed on Nov. 18, 2004.

(51) Int. Cl. G01N 27/26

(52) U.S. Cl. 205/791; 204/412

(57) ABSTRACT

A system and method for potentiostat calibration includes a conductive substrate, a model film placed on the substrate, an electrolyte, and a potentionstat for obtaining calibration data from tests conducted on the model film. The electrolyte is disposed at a first side of the model film opposite the substrate, and in electrical contact with the model film. The potentiostat includes a working electrode, a reference electrode, and a counter electrode. The working electrode is electrically connected to the substrate, and the reference and counter electrodes are positioned at the electrolyte.

### CROSS-REFERENCES TO RELATED APPLICATIONS

This application claims priority to U.S. Provisional Patent Application No. 60/629,188, entitled “High-Throughput Corrosion Screening”, filed Nov. 18, 2004, and to U.S. Provisional Patent Application No. 60/692,988, entitled “Calibration Method and Apparatus for Potentiostats”, filed Jun. 22, 2005. Those applications are hereby each incorporated by reference in their entireties.

### STATEMENT OF GOVERNMENT INTEREST

The present invention was made, in part, with government funding under Air Force Office of Scientific Research (AFOSR), under Grant No. F49620-02-1-0398. The U.S. Government has certain rights in this invention.

### BACKGROUND OF THE INVENTION

Conventional electrochemical testing methods for corrosion protective coatings are time demanding and require large sample sizes. Thus, the majority of techniques like conventional Electrochemical Impedance Spectroscopy (EIS), Electromechanical Noise Measurement (ENM), etc. are not suitable to perform rapid screenings of various paint systems or corrosion inhibitors in terms of their corrosion protective effect. The concept of combinatorial chemistry and high throughput screening, already well established in the pharmaceutical industry, is nowadays entering the field of materials science. Due to the complexity of coatings systems, the application of combinatorial methods to polymer synthesis, coatings formulation and testing is not straightforward. More specifically, conventional electrochemical testing methods for corrosion protective coatings such as EIS are time demanding and require large sample sizes.

Calibration and troubleshooting of potentiostats used to conduct tests on metal samples traditionally involves “dummy cell” circuits used in place of actual coating samples to calibrate the equipment. However, these techniques have limitations. The dummy cells are suitable for use at impedances in the range of Ohms to kiloOhms, while corrosion protective coatings sought to be tested typically involve substantially higher impedances (i.e., in the range of GigaOhms or higher). The dummy cells do not provide for calibration at impedance ranges similar to those of many testing procedures, which reduces the effectiveness of the calibration (or troubleshooting) procedures. In addition, actual samples of commercial coatings are unpredictable. Films of coating sample materials exhibit problems such as: fluctuating film thickness; defects such as pinholes and craters; variations in composition, surface roughness and crosslink density over the sample area; and high water sensitivity, which changes response over time. As a result, the EIS spectra of replicate samples of these coating films vary by up to several orders of magnitude, making them poorly suited for calibration and troubleshooting.

Therefore, it is desired to implement a high throughput EIS apparatus and protocol for the evaluation of corrosion protective properties of coatings, while providing small sample sizes, automated workflow, rapid and simple data acquisition and evaluations resulting in a relative ranking of different coating materials. In addition, it is desired to provide an effective and reliable way to calibrate such an EIS apparatus for testing coating samples.

### BRIEF SUMMARY OF THE INVENTION

A system for potentiostat calibration according to the present invention includes a conductive substrate, a model film placed on the substrate, an electrolyte, and a potentionstat for obtaining calibration data from tests conducted on the model film. The electrolyte is disposed at a first side of the model film opposite the substrate, and in electrical contact with the model film. The potentiostat includes a working electrode, a reference electrode, and a counter electrode. The working electrode is electrically connected to the substrate, and the reference and counter electrodes are positioned at the electrolyte. The present invention further includes a method for calibrating and troubleshooting a potentiostat.

### BRIEF DESCRIPTION OF THE DRAWINGS

FIG. 1 is an exploded perspective view of the apparatus of the present invention.

FIG. 2 is a diagrammatic view of the electrochemical cell created in each well of the present invention when performing high throughput EIS.

FIG. 3 is a graph of an impedance modulus /Z/ in ohms (Ω) versus frequency in Hz for a number of coating samples.

FIG. 4 is a graph of the slopes for the curves of FIG. 3.

FIG. 5 shows a potentiostat calibration system according to the present invention.

### DETAILED DESCRIPTION

The present invention relates to an apparatus for use in performing high throughput Electrochemical Impedance Spectroscopy (EIS) testing, and methods for calibrating that equipment and performing EIS testing with it. The apparatus is configured to allow for miniaturizing the electrochemical cell used to perform the EIS testing.

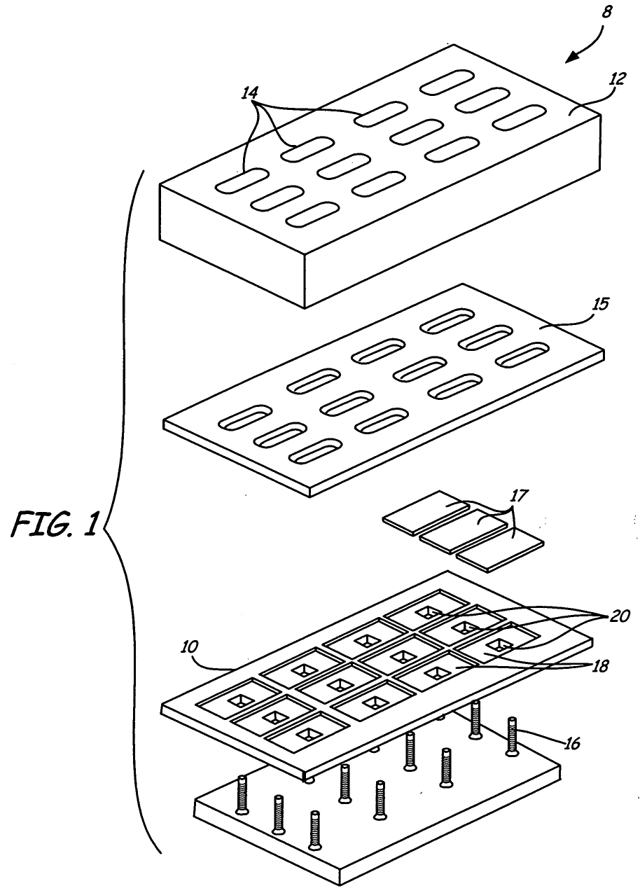

FIG. 1 is an exploded view of an apparatus 8 for use in high throughput EIS testing. Shown in FIG. 1 is a base plate 10, a top plate 12 having a plurality of slots or wells 14, a gasket 15, and a working electrode connection assembly 16. The slots 14 of the top plate 12 extend through the top plate 12, so that an area on the base plate 10 can be accessed through the slots 14. A sample to be tested is disposed on a metal substrate (or plate or panel) 17. Preferably, the slots 14 on the top plate are sized so that a sample to be tested (e.g., a coating sample) having a desired testing area of about A=3 cm² on the panel 17 can be exposed to an electrolyte placed in the slots 14.

The top plate 12 is of any suitable thickness that allows for the slots 14 to have a height suitable for the slots 14 to be filled with a desired amount of electrolyte solution. The top plate is formed of a non-conductive material. The gasket 15 is placed between top plate 12 and the coated metal sample to prevent the electrolyte from leaking out, and can have a hole corresponding to the slots 14 in the top plate 12. The choice of the gasket material can be any suitable material (e.g., silicone) which forms the desired seal between the top plate 14 and the coated metal samples located on the base plate 10.

The base plate 10 comprises a plurality of molds 18, in which coated metal samples on plates 17 (or other items to be tested) can be placed. The molds 18 comprise holes 20 in approximately the middle (i.e., in about the center of each mold 18), which enable electrical contact of a sample (e.g., the metal substrate of a painted metal sample) with a potentiostat through working electrode connection assemblies 16. The working electrode connection assemblies 16 extend through the holes 20 in the base plate 10, and can be biased (e.g., spring-loaded) electrical contacts that can contact the plates 17.

Though it may be any suitable size, a base plate 10 that is about four inches by about eight inches is preferred because such a base plate 10 is of a standard size that is readily used within common high throughput screening work flows. Similarly, any number of molds 18 may be used. However, twelve molds 18 are preferred, so that the base plate 10 can receive twelve coated metal samples on its surface. The size of the molds 18 may be any suitable size. Preferably, the size of the mold, and thus the size of the coated sample area, is about one to three square centimeters.

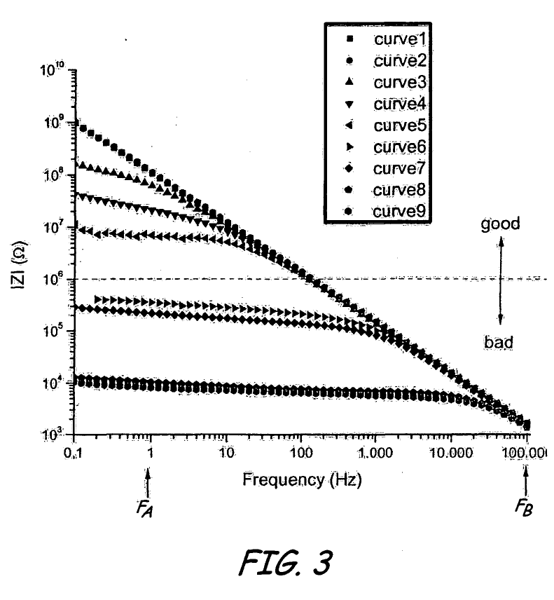

The base plate 10 may be formed of any suitable material that is electrically insulating. To allow its use in the electrochemical cell described with reference to FIG. 3, the base plate 10 is preferably formed of a plastic material such as Teflon®. The base plate 10 has holes 20 in the molds 18 which provide a location for the working electrode connection 16 to connect to the samples to be tested (i.e., the coated metal panels 17) in each mold 18.

The samples which are placed in the molds 18 of the base plate 10 are formed by applying a coating material to the metal panels 17. Each coated metal panel 17 is then placed in the mold 18. Any variety of different paint application methods that ideally result in homogeneous film thickness distributions can be used when creating samples to be tested by applying the desired coating onto the metal panels 17 placed into the molds 18 on the base plate 10.

In preparing the apparatus 8 for use in a high throughput EIS test, various coating samples on panels 17 are placed into the molds 18 on the base plate 10. The top plate 12 is then positioned over the base plate 10 so that the slots 14 are positioned over the coating samples in the molds 18. The apparatus 8 can then be clamped together. Next, the wells 14 are filled with electrolyte, and then the EIS process can be performed.

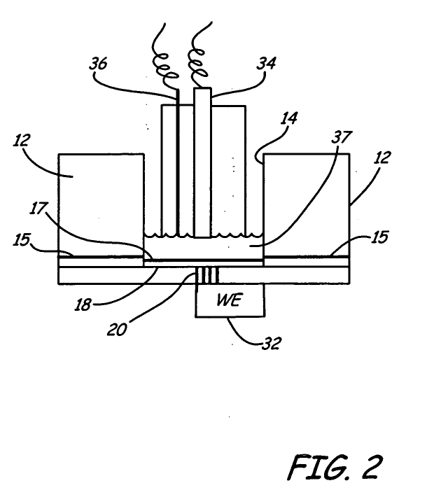

The complete electrochemical cell is shown schematically in FIG. 2. Each of the cells 30 comprises a coated metal panel functioning as working electrode 32, a reference electrode 34, and a counter electrode 36. The cell 30 also comprises a well 14 which is defined by the top plate 12 filled with electrolyte 37. In operation, each of the twelve wells 14 can be equipped with a full set of electrodes, or, a device containing reference electrode 34 and counter electrode 36 can be moved automatically among slots 14 from slot to slot gathering data. The electrolyte 37 need not be moved with the reference and counter electrodes 34 and 36 in embodiments where those electrodes are moved among the wells 14.

It is important to note that EIS is an AC testing procedure, as distinguished from DC methods such as potentiodynamic scans. EIS enables testing of corrosion protective properties as well as barrier properties of coatings. EIS testing can be performed on defect-free samples.

### Testing Protocols

Recording a full EIS spectrum over a large frequency range yields useful information, but is also very time intensive. Ideally, the high throughput strategy should enable the differentiation of different coatings on the basis of a few selected frequencies, preferably in the high frequency region (f≧1 Hz). In addition, the measurement should be reproducible and the elimination of error sources should have a high priority.

With regard to the development of a high throughput EIS testing protocol, a small sample size is crucial. When using small sample areas one has to be aware that the data are less reproducible and the dielectric constant of the material is not obtained accurately. However, high throughput experiments usually are relative comparisons of different coating systems, and it should be possible to choose a screening criterion that does not depend on sample size. One possible data evaluation strategy is laid out below.

The time required for measurement and data recording should be in the range of seconds. This means that frequencies below 1 Hertz (Hz) should not be used in the measurements. Also, the data evaluation should be simple and rapid and automated and result in a yes/no result. Hence, gaining data by fitting them to equivalent circuit models should be avoided as this process has to be done manually and requires the knowledgeable choice of the appropriate model. In addition, the error introduced by the data evaluation protocol should be as small as possible. Again, this eliminates the use of equivalent circuits; relative error values for some circuit elements are often over 10% even for a good fit. In this context, frequencies below 1 Hz are generally noisier than higher frequencies.

In one embodiment of the present invention, a two frequency method is employed. After examining various sets of impedance data, it is believed that at very high frequencies (about 10⁵ Hz and above) the impedance modulus (/Z/) value for all curves are the same: about 10³ to about 10⁴ Ohm. This is expected since at very high frequencies the electrolyte resistance (which is the same for all samples as long as the same electrolyte is used) eventually becomes noticeable. At 1 Hz, the spectra separate according to each coating's performance.

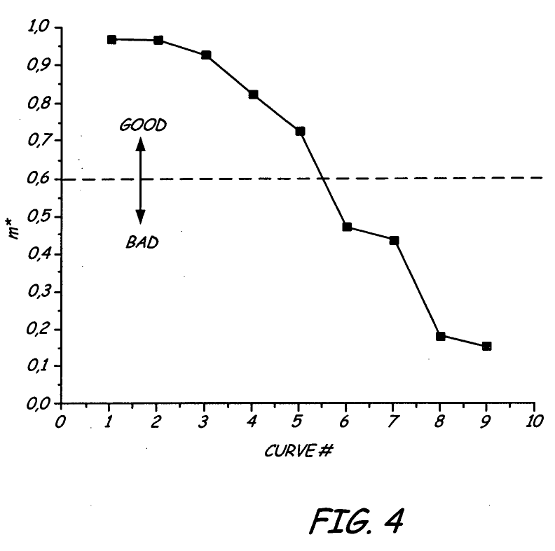

FIG. 3 is a graph of /Z/ in ohms (Ω) versus frequency in Hz for a number of coating samples (curve1-curve9). The coating samples correspond to a single type of coating at different stages in an accelerated weathering protocol; however, in further embodiments of the present invention, different coating samples can correspond to different types of coatings. For the tests illustrated in FIG. 4, two measurements are performed at two different frequencies, F_{A}=1 Hz and F_{B}=10⁵ Hz. The measurement at F_{A} (1 Hz) is taken at a frequency that enables the distinction between coatings with different performance. The measurement at F_{B} (10⁵ Hz) is a control measurement that shows if the equipment is working properly.

It is known that the impedance value /Z/ for measurements at this frequency has to be about 10³ to about 10⁴ Ohm. If the /Z/ value is not in this range, this may be an indication that there is a problem with the equipment, e.g., an electrical connection or an electrode might be malfunctioning.

By calculating a slope m between two data points corresponding to F_{A} and F_{B}, additional information can be obtained. The slope m is calculated according to the following equation:

$$m = \frac{log / Z {/}_{1 H z} - log / Z {/}_{{10}^{5} H z}}{log 1 - log {10}^{5}} = - \frac{log \frac{/ Z {/}_{1 H z}}{/ Z {/}_{{10}^{5} H z}}}{5}$$

For a perfect coating, m is close to −1, and for a failed coating m is close to 0. A coating showing m=−1 is purely capacitive and does not have any significant defects. This is important information that cannot be obtained by looking at measurements at one frequency alone. It has to be kept in mind that the prerequisite for data evaluation based on the slope m is a common impedance value at 10⁵ Hz for all coatings.

A value m* between 0 and 1 characterizes the corrosion protective performance of the coating. The m* values correspond readily to the relative ranks of the full range impedance data of various EIS data sets evaluated. A further advantage of this method is the ability to plot different coatings and their change in time in the same graph, which is not possible when presenting the full impedance spectrum for different coatings.

FIG. 4 is a graph of the slopes for the curves of FIG. 3. For simplification, the negative slope m* is plotted (where m*=−m), meaning the best coatings have a value of close to 1. As seen in FIG. 4, the coating initially shows purely capacitive behavior resulting in a m* value of close to 1 (i.e, at curves 1 and 2). The performance of the coating samples drops after some time in the weathering chamber (i.e., for coating samples subjected to greater weathering), the curves are leveling off at a resistive plateau in the low frequency end of the spectrum and m* decreases accordingly. Curves 8 and 9 indicate that the coating has failed and the measured coating resistance approaches the value for bare metal. This development is expressed in m* which decreases to <0.2. For a high throughput screening process it is necessary to determine a failure criterion to distinguish between “good” and “bad” coatings. In one embodiment, that criterion is chosen at /Z/_{1Hz}=10⁶ Ohm. As shown in the following equation, an impedance value of 10⁶ Ohm corresponds to m*=0.6:

$${m}^{*} = \frac{log \frac{{10}^{6}}{{10}^{3}}}{5} = 0.6$$

In further embodiments, the failure criterion can be redefined at a different value depending on the particular system and conditions.

As shown in FIG. 3, there are five curves that satisfy this criterion (curves 1-5), and four that fail (curves 6-9). The same result, in terms of relative ranking of the curves and meeting the chosen failure criterion, is obtained with the slope method, as shown in FIG. 4, measuring only two frequencies out of a possible spectrum.

By measuring two selected frequencies, for example, F_{A}=1 Hz and F_{B}=10⁵ Hz, the EIS measurement procedure can be completed in the order of seconds. By knowing the impedance value at 10⁵ Hz, a way is given to verify the proper operation of the electrochemical equipment. The calculation of a “slope” between the two data points can be done with simple technical means in an automated manner (even a commercially available spreadsheet program such as MICROSOFT EXCEL can be used to handle the calculation) and no fitting to equivalent circuit models is necessary.

The apparatus and process described herein may be integrated into any suitable and existing combinatorial workflow, including polymer synthesis, coatings formulation and application. In such instances, it is preferable that the high throughput method be capable of dealing with a panel of aluminum alloy containing up to 12 coating spots (or samples) of a size of 3 cm² or larger.

In the case of a modified EIS setup, the electrochemical cell can be miniaturized and the setup adjusted for the use in an automated manner. Further, the high throughput EIS apparatus may be used in connection with a robotic system and a measurement protocol that allows for rapid data recording. Further, it may be desirable to take advantage of accelerated weathering strategies like thermal cycling and may be desirable to investigate the influence of film thickness and type of immersion solution on the speed of coating degradation to speed up the data acquisition.

Finally, the method is preferably verified by means of other coatings systems of known corrosion protective properties.

### Calibration Standards

In order to reduce error sources and obtain highly reproduceable measurement, it is desirable to have calibration and troubleshooting protocols. According to the present invention, potentiostats for EIS testing systems (including but not limited to the testing system of the present invention described above), can be calibrated using thin polymer model films. A “model film” refers to a film that differs in some way from a sample desired to be tested, but has at least one electrical characteristic similar to that of the sample desired to be tested. The model films provide a reference sample that can be tested and analyzed, like a coating sample, and compared to pre-determined or otherwise established nominal material properties of the model films in order to calibrate the testing equipment and reduce errors in testing of actual samples. This use of model films represents an alternative calibration method that can replace the use of electronic dummy cells or actual coating samples for calibration and troubleshooting. The results of testing and analysis of a model film are highly reproducible, and therefore can provide a reliable calibration and troubleshooting control standard. The use of model films also permits testing in impedance ranges that closely reflect that of actual coating samples desired to be tested with EIS testing systems, in addition to other advantages.

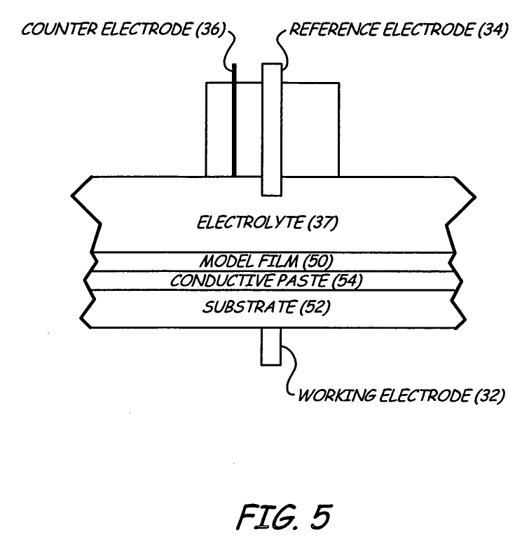

In order to conduct calibration and troubleshooting of a potentiostat, a model film is first mounted on a metal substrate and connected to the testing apparatus (e.g., an EIS testing system according to the present invention). FIG. 5 shows a potentiostat calibration system that includes a model film 50, conductive paste 54 and substrate 52. The model film 50 mounted on the substrate 52 is connected to a potentiostat assembly having a working electrode 32, a reference electrode 34 and a counter electrode 36, much like an actual test sample would be connected-during EIS testing. It should be noted that an electrolyte 56 can be held adjacent to the model film 50 over only a portion of a surface of the model film 50, such that the electrolyte 56 is spaced from edges of the model film 50.

The model film 50 has an impedance value in generally the same range as the samples (e.g., coating samples) desired to be tested. Thus, a potentiostat can be calibrated with the model film 50 over the entire impedance range that is relevant for measurements on, for example, organic coating systems. The model film 50 can be made from a commercially available polymer film. Desirable characteristics of model films 50 include: relatively constant and reproducible film thickness; a reproducible EIS spectra; known electrical properties; homogeneous composition; relatively defect-free; having smooth surfaces; and having low water sensitivity. Suitable model films 50 can comprise materials such as polyvinylfluoride release films (e.g., TPC 10 and TTR 20 Tedlar® films available from DuPont, Wilmington, Del.), polyethylene terephthalate (PET) films (e.g., OptiLiner™ and SupraLiner™ release films available from Saint-Gobain Performance Plastics, Northboro, Mass.), polyurethane protective tapes (e.g., Polyurethane Protective Tape 8671, available from 3M, Saint Paul, Minn.), polyethylene/polypropylene films, various other polyvinyl films, fluoropolymer films, polyester films, polyether films, polyamide films, and polyurethane films. The most desirable dimensions (i.e., thickness and surface area) of the model film 50 will vary according to the particular type of model film 50 used. In some embodiments, minimum surface areas may be desirable. For instance, in the case of the dielectric constant of the model film 50, a minimum surface area of about 11.4 cm² was found desirable to avoid measurement artifacts introduced by edge effects for some types of model films.

The substrate 52 can be a stand-alone metal panel, for example, an aluminum alloy 2024 T3 panel.

The conductive paste 54 is optionally disposed between the model film 50 and the substrate 52, as desired. The conductive paste 54 can help avoid the entrapment of air bubbles between the model film and the metal panel and also better simulate adhesion of a coating to the substrate. Suitable conductive pastes 54 include, for example, CircuitWorks® CW7100 silver conductive grease (available from ITW Chemtronics, Kennesaw, Ga.) and a paste made of carbon black and silicone oil. It should be recognized that a conductive paste need not be used, for instance, a conductive paste may be unnecessary where the model film 50 is a tape having a pre-applied adhesive.

The model film 50 is tested and analyzed, using the same procedures described above for testing an actual sample, and compared to pre-determined or otherwise established nominal values in order to calibrate the testing equipment and reduce errors in testing of actual samples. For example, tested values of the model film 50 can be compared to material properties of the model films. For some model films 50, material reference data may be available against which tested values can be compared to calibrate the potentiostat. Alternatively, control or reference values can be determined through calibration testing.

By using defined, homogeneous and relatively defect-free model films 50, it is feasible to reduce or eliminate error sources in EIS data that are related to the samples themselves. It is thus possible to study data variability originating from the EIS measurement procedure, such as edge effects arising from non-uniform field and current distributions and the significance of the impedance limit of the potentiostat.

In order to validate the performance of EIS measurements on small sized samples, experiments have been conducted with model films, such as polyvinylfluoride release films, polyethylene terephthalate (PET) films and polyurethane protective tapes. Experiments have shown that it is possible to obtain very reproducible EIS spectra (in contrast to commercial coatings) when testing model films. Parameters gained from EIS spectra, such as film resistivity, dielectric constant, and exponent n of the non-ideal capacitance, were evaluated in dependence of sample area and film thickness and, where applicable, compared to the nominal material properties indicated in the technical data sheet for the model films tested. The values obtained by EIS experiments correlated well with the actual values, validating the EIS technique for the determination of absolute values of electrical properties of coating samples.

It should be recognized that the calibration and troubleshooting protocol described above can provide numerous advantages. The model films have impedance values in about the same range as the types of coatings desired to be tested using EIS techniques, thereby allowing the potentiostat to be calibrated over the entire impedance range relevant for measurements on organic coating systems, etc. Testing equipment can thus be calibrated according to a standard that is similar to the real coatings desired to be tested. Also, reproducibility of EIS spectra is in the same range (for some films even exceeds) as the reproducibility of spectra of dummy cells. A variety of different model film sets can be created such that for nearly any desired coating system an appropriate standard can be found to make calibration and trouble shooting more specific and accurate for the particular application involved.

Although the present invention has been described with reference to preferred embodiments, workers skilled in the art will recognize that changes may be made in form and detail without departing from the spirit and scope of the invention. For instance, the calibration standards described above can be used a variety of testing systems and its us is not limited to any particular arrangement or configuration of testing equipment.

1. A system comprising:
a conductive substrate;
a model film placed on the substrate;
an electrolyte disposed at a first side of the model film opposite the substrate, and in electrical contact with the model film; and
a potentionstat for obtaining calibration data from tests conducted on the model film, the potentiostat having a working electrode, a reference electrode, and a counter electrode, wherein the working electrode is electrically connected to the substrate, and wherein the reference and counter electrodes are positioned at the electrolyte.

2. The system of claim 1, wherein the model film comprises a polymer material.

3. The system of claim 1 and further comprising:
a conductive paste disposed between the model film and the substrate.

4. The system of claim 3, wherein the conductive paste is arranged as a thin film.

5. The system of claim 1, wherein the first side of the model film has a surface area of at least about 11.4 cm².

6. The system of claim 1, wherein the substrate is a stand-alone plate.

7. The system of claim 1, wherein the substrate comprises a metallic material.

8. The system of claim 1, wherein the substrate comprises at least a portion of a base plate of an Electrochemical Impedance Spectroscopy testing system.

9. The system of claim 1, wherein the model film includes an adhesive disposed thereon.

10. The system of claim 1, wherein the model film has an impedance range that is similar to coating samples desired to be tested using the potentiostat.

11. The system of claim 1, wherein the model film has a substantially constant film thickness.

12. The system of claim 1, wherein the model film has a reproducible EIS spectra.

13. The system of claim 1, wherein the model film has known electrical properties.

14. The system of claim 1, wherein the model film has a substantially homogeneous composition.

15. The system of claim 1, wherein the model film is substantially defect-free.

16. The system of claim 1, wherein the model film has substantially smooth outer surfaces.

17. A method for calibrating a potentiostat, the method comprising:
engaging a model film with the potentiostat;
testing the model film with the potentiostat to obtain calibration test data relating to electrical properties of the model film; and
comparing the calibration test data to control data.

18. The method of claim 17 and further comprising:
placing the model film on a conductive substrate.

19. The method of claim 18 and further comprising:
placing a conductive paste between the model film and the substrate.

20. A method of calibrating a potentiostat used for Electrochemical Impedance Spectroscopy testing of coating samples, the method comprising:
engaging a polymer model film with the potentiostat, wherein the model film has an impedance in an range that approximates an impedance for a sample desired to be tested with the potentiostat;
testing the model film with the potentiostat to obtain calibration test data relating to electrical properties of the model film;
comparing the calibration test data to control data; and
adjusting a recorded output of the potentiostat as a function of the comparison between the calibration test data and the control data.
